(19) United States
(12) Patent Application Publication
(10) Pub. No.: US 2026/0099752 A1
(43) Pub. Date: Apr. 9, 2026

(54) SYSTEMS AND METHODS FOR QUANTUM CIRCUIT SIMULATION USING TENSOR NETWORKS

(71) Applicant: HSBC Technology & Services (USA) Inc., Chicago, IL (US)

(72) Inventor: Mekena Metcalf, Dixon, CA (US)

(21) Appl. No.: 18/905,152

(22) Filed: Oct. 3, 2024

(51) Int. Cl. G06N 10/60; G06N 10/20

(52) U.S. Cl. CPC G06N 10/60; G06N 10/20

(57) ABSTRACT

Embodiments of the present disclosure provide functionality to tensor network framework designed for quantum kernel methods and demonstration of tensor network effectiveness at scaling this application. Quantum kernels capture the distance between data points in quantum feature space by evaluating the quantum state overlaps associated with each data point. It has been found that expressing data in quantum feature space may produce more separable data that improves the results of linear classifiers. The different kernel elements may be computed independently, and parallel processing may be exploited to significantly reduce computational time, enabling to train on more data. Thus, quantum kernels continue to improve classification metrics with the addition of more training data and more features.

### FIELD

The present application relates to computer architecture for quantum based computing and more specifically, to systems and methods for quantum circuit simulation using tensor networks.

### INTRODUCTION

Solving quantum models is a technical challenge. Conventional quantum-based machine-learning frameworks are usually based on toy models with unrealistic data specifications, because of algorithm scaling difficulty. There have been advances in solving quantum models with respect to model performance assessment on classical data sets, yet vector representations of quantum states are limited in terms of memory, as the required memory scales exponentially with the number of quantum bits (“qubits”), making simulation at meaningful scale prohibitive.

Alternatively, one may use a quantum computer to solve quantum models, but modern quantum computers are known to be limited by design, as noise typically arises from imperfect operations and other environmental effects degrade the learning performance.

### SUMMARY

An improved computing approach and corresponding system for quantum kernel enhanced training of a target machine learning model data architecture using a quantum feature map applied to training data set is proposed. The system can be a computer server that includes a plurality of computer processors, operating in conjunction with computer memory and non-transitory computer readable storage media. The system is adapted to improve overall machine learning training by generating a quantum kernel data object using a quantum feature map transformation, and then using the quantum kernel to train a machine learning model. The generated quantum kernel is especially useful transformation that is used for representation of data in a quantum state space so that previous computing limitations can be surpassed for improved machine learning for complex, high dimensionality data, allowing for an enhanced ability to scale both in feature dimension and training data size.

As part of the training process, a quantum kernel is generated by first receiving a corresponding data batch of the training data set; and also receiving a parameterized quantum circuit, and then transforming each data point in the data batch using the parameterized quantum circuit as the quantum feature map to convert the data point into a quantum-space data point having qubits based on a manifold space defined by the parameterized quantum circuit, each quantum-space data point having states represented using a tensor network. The quantum kernel represents a quantum computing enhanced training data set wherein each data point of the training data set is expanded based on the expectation values of the qubits for capturing a distance between each data point in the manifold space by simulating the quantum state overlaps associated with each data point. A target machine learning model data architecture is trained using the quantum enhanced training data set to generate an output trained target machine learning model data architecture.

In an aspect, the tensor network represents a quantum state of the quantum kernel using a Matrix Product State (MPS) architecture, and a matrix product state is used for wavefunction representation, and a matrix product operator is used to represent one or more quantum gates used for conducting operations on the tensor network.

In an effort to distribute workload, in a variation, the plurality of processors can utilize a round-robin parallelization strategy for generating the quantum kernel, wherein each processor first computes an initial set of expectation values corresponding to the data batch, and receives a set of expectation values from another processor of the plurality of processors relating to a next data batch, and computes expectation values between the data batch and the next data batch, continuing until all kernel elements of the quantum kernel are determined using different pairs of expectation values. In this variation, each of the plurality of processors is configured to send states to another processor in accordance with the round-robin parallelization strategy until all Gram matrix entries are computed.

An optimization for rectangular kernel matrices is also proposed where the round-robin parallelization strategy includes processors grouped to handle square tiles, with remaining processes corresponding to non-square tiles receiving MPS subsets from the grouped processors through additional message passing.

During machine learning inference, when a new inference data point is provided for classification to the trained target machine learning model data architecture, the new data point is first processed using the parameterized quantum circuit for simulation as a Matrix Product State for generation of an inference kernel, and the inference kernel processed against a plurality of stored expectation values and the target machine learning model data architecture to generate a classification output.

The approach can be practically integrated in real world applications where high dimensionality and high complexity data is used to train complex models. The quantum kernel approach can be implemented by a specialized computer server that resides at a data center and is configured for generating, training, and/or inference using quantum kernels as described herein. In this example, a plurality of processors that are networked distributed computing resources that are selected and provisioned for usage based at least on a determination of a bond dimension characteristic corresponding to the quantum feature map used for the quantum kernel enhanced training and the amount of training data used for the model. The determination includes generating a small-scale preliminary version of the quantum kernel for performance analysis.

In a specific, non-limiting example for usage at a financial institution, the trained target machine learning model data architecture can be configured for fraud detection/fraud simulation, wherein the new inference data point is a data point having data fields corresponding to features of a transaction, and the generated classification output from the trained target machine learning model data architecture is a logit corresponding to an estimated probability that the new inference data point is classified in accordance with a specific label. The specific label may be a binary classification between fraudulent and non-fraudulent, for example.

Embodiments of the present disclosure provide functionality to tensor network framework designed for quantum kernel methods and demonstration of tensor network effectiveness at scaling this application. Quantum kernels capture the distance between data points in quantum feature space by evaluating the quantum state overlaps associated with each data point. The difference in expectation values are derived from the quantum state associated with each data point. It has been found that expressing data in quantum feature space may produce more separable data that improves the results of linear classifiers. The different kernel elements may be computed independently, and parallel processing may be exploited to significantly reduce computational time, enabling to train on more data. Thus, quantum kernels continue to improve classification metrics with the addition of more training data and more features.

The foregoing has outlined the features and technical advantages in order that the detailed description that follows may be better understood. Additional features and advantages will be described hereinafter. It should be appreciated by those skilled in the art that the conception and specific embodiment disclosed may be readily utilized as a basis for modifying or designing other structures. It should also be realized by those skilled in the art that such equivalent constructions do not depart from the spirit and scope of the embodiments described herein. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the embodiments described herein.

### BRIEF DESCRIPTION OF THE DRAWINGS

For a more complete understanding of the disclosed methods and apparatuses, reference should be made to the implementations illustrated in greater detail in the accompanying drawings, wherein:

FIG. 1 is a block diagram of a system for quantum kernel enhanced training of a target machine learning model data architecture in accordance with embodiments of the present disclosure;

FIG. 2 is a flow diagram of a method for quantum kernel enhanced training of a target machine learning model data architecture in accordance with embodiments of the present disclosure.

FIG. 3 is a diagrammatic representation of a Matrix Product State (MPS) in accordance with embodiments of the present disclosure.

FIG. 4 is other diagrammatic representations of an MPS in accordance with embodiments of the present disclosure.

FIG. 5 is yet other diagrammatic representations of an MPS in accordance with embodiments of the present disclosure.

FIG. 6 is a diagrammatic representation of a tensor network having a Pauli operator in accordance with embodiments of the present disclosure.

FIG. 7 is a round-robin parallelization process for computing a Gram matrix in accordance with embodiments of the present disclosure.

FIGS. 8A-8B are graphs of the area under the curve (AUC) prediction score as a function of the number of features in accordance with embodiments of the present disclosure.

FIG. 9 is a schematic diagram of an electronic device in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

An improved computing approach and corresponding system for quantum kernel enhanced training of a target machine learning model data architecture using a quantum feature map applied to training data set is proposed.

The system can be a physical computer server that includes a plurality of computer processors, operating in conjunction with computer memory and non-transitory computer readable storage media. The system is adapted to improve overall machine learning training by generating a quantum kernel data object using a quantum feature map transformation, and then using the quantum kernel to train a machine learning model. The generated quantum kernel is especially useful transformation that is used for representation of data in a quantum state space so that previous computing limitations can be surpassed for improved machine learning for complex, high dimensionality data, allowing for an enhanced ability to scale both in feature dimension and training data size. The technological approach proposed herein is directed to the training of machine learning models using quantum circuits. Of particular note is that the proposed approach describes using a tensor network to represent quantum-space data points and to generate quantum kernels using those data points enabled to reduce the computational time and increase the computational power required for training machine learning models.

Quantum feature space may produce more separable data as compared to classical counterparts. A particular implementation of the quantum kernels generation was made possible by using round-robin parallelization, in which processors compute expectation values between data batches until all kernel elements of the quantum kernel are determined. In this implementation, the data point expressed as a Matrix Product State (MPS) and the quantum kernel elements are independent. This independence enables parallelization of the processes using multiple processors in communication with each other. One can appreciate that, by using a large number of processors for the simulations, the computational time is greatly reduced compared to conventional techniques, thereby elevating the scalability of quantum model simulations.

It will be appreciated that quantum machine learning algorithms based on the technology presented herein may be implemented in financial institutions for detection of fraudulent behavior, e.g., by examining transaction histories, user behaviors, and other relevant data. The benefits provided by the proposed approach are in the form of an efficient, accurate and scalable solution for detecting fraudulent behavior, in some cases in real time.

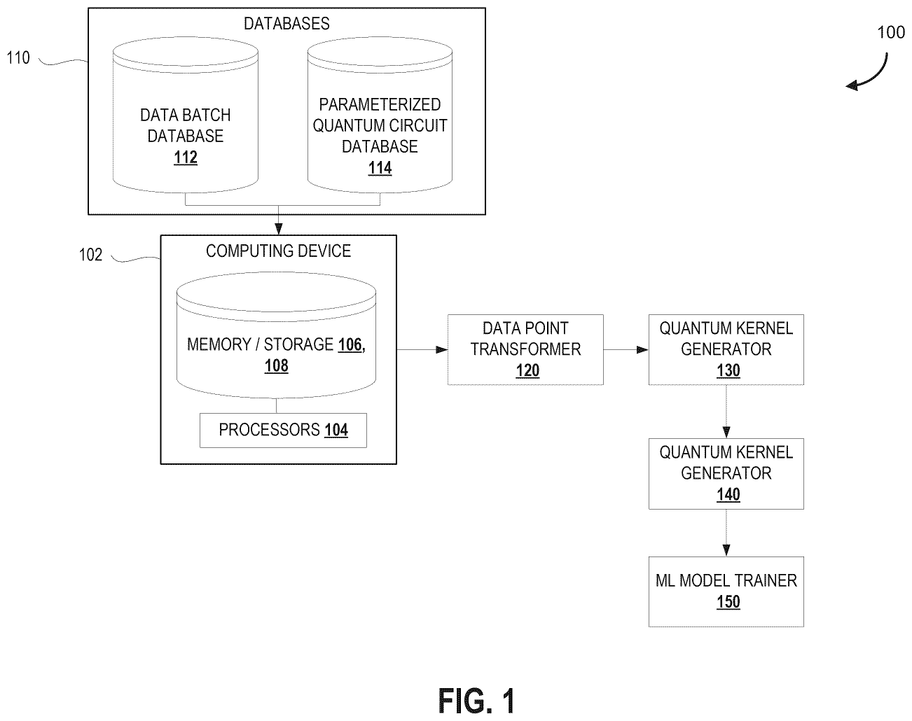

Referring to FIG. 1, block diagram illustrating aspects of a system 100 for quantum kernel enhanced training of a target machine learning model data architecture in accordance with embodiments of the present disclosure is shown as a system 100. The system 100 may be configured to train machine learning model data architecture using quantum computing enhanced training data set generated via a quantum kernel.

As shown in FIG. 1, the system 100 includes a computing device 102 in communication with database 110. Although primarily described with reference to the computing device 102, it should be understood that the functionality provided by the computing device 102 may be deployed in other configurations and implementations. For example, functionality of the computing device 102 may be provided in a distributed computing implementation (e.g., multiple computing devices 102) or via computing resources deployed in the cloud. The computing device 102 includes a plurality of processors 104 a memory 106 and a storage medium 108. The one or more processors 104 may include one or more microcontrollers, application specific integrated circuits (ASICs), field programmable gate arrays (FPGAs), central processing units (CPUs) having one or more processing cores, or other circuitry and logic configured to facilitate the operations of the computing device 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the computing device 102 may be stored in the memory 106 or the storage medium 108 in the form of instructions that, when executed by the one or more processors 104, cause the one or more processors 104 to perform the operations described herein with respect to the computing device 102, as described in more detail below. Additionally, the memory 106 or the storage medium 108 may be configured to store the databases 110. Alternatively, the databases 110 may be stored on a remote location in communication with the computing device 102.

The databases 110 include a data batch database 112 and an a parameterized quantum circuit database 114, which are configured for providing data batches and parameterized quantum circuit to the computing device 102. It will be appreciated that the size and format of the data contained in the databases 110 may vary depending on the implementation. The data batch database 112 provides data that is a subset of a training data set and that may include labeled and/or unlabeled data. The parameterized quantum circuit database 114 contains a variety of quantum circuit with known parameters, which are optimized using the trained machine learning model.

The computing device 102 is coupled to a data point transformer unit 120, which is configured to transform each data point in the data batch using the parameterized quantum circuit into a quantum-space data point. The data point transformer unit 120 is coupled to a quantum kernel generator 130, which generates a quantum kernel representing a quantum computing enhanced training data set by evaluating expectation value differences associated with each data point. The quantum kernel generator 130 is coupled to a machine learning model trainer 140, which is configured to train the target machine learning model data architecture using the quantum computing enhanced training data set. The functionality of the data point transformer unit 120, the quantum kernel generator 130 and the machine learning model trainer 140 will be further described below.

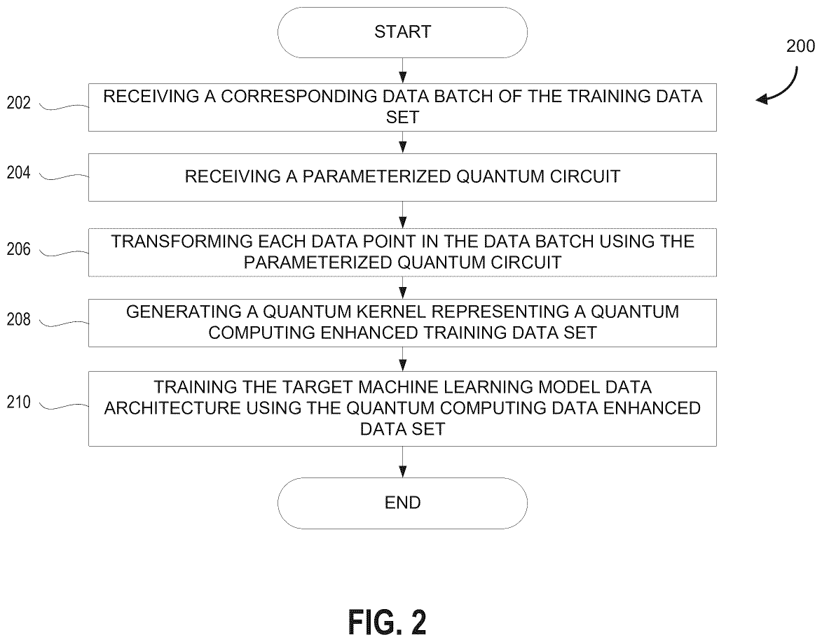

Referring to FIG. 2, a flow diagram of a method for quantum kernel enhanced training of a target machine learning model data architecture using a quantum feature map applied to training data set in accordance with embodiments of the present disclosure is shown as a method 200. In aspects, the operations of the method 200 may be stored as instructions that, when executed by one or more processors (e.g., the processors 104 of FIG. 1), cause the one or more processors to perform the steps of the method 200. In aspects, the method 200 may be performed by a device (e.g., the computing device 102 of FIG. 1).

At step 210, the method 200 includes receiving, by the computing device 102, a corresponding data batch of the training data set. It will be appreciated that the training data set may be selected to support various quantum computing tasks, including, but not limited to, quantum control, quantum tomography, noise spectroscopy, and the like. In some embodiments, the training data set is obtained from the database 110.

At step 220, the method 200 includes receiving, by the computing device 102, a parameterized quantum circuit. At a high level, a parameterized quantum circuit consists of a sequence of quantum gates, some of which are parameterized by adjustable variables. These parameters are typically optimized when performing the method 200 to minimize, e.g., a cost function. In some embodiments, the parameterized quantum circuit is obtained from the database 110.

At step 230, the method 200 includes transforming, by the data point transformer unit 120, each data point in the data batch using the parameterized quantum circuit as the quantum feature map to convert the data point into a quantum-space data point having qubits based on a manifold space defined by the parameterized quantum circuit. It will be appreciated that the manifold space is a space where each data point has a neighborhood that is homeomorphic, i.e., that is topologically equivalent. At step 230, each quantum-space data point has states represented using a tensor network.

At step 240, the method 200 includes generating, by the quantum kernel generator 130, a quantum kernel representing a quantum computing enhanced training data set. Each data point of the training data set is expanded based on the expectation values of the qubits for capturing a distance between each data point in the manifold space by simulating quantum state overlaps associated with each data point.

It will be appreciated that kernel machines may be used in a variety of machine learning methods to capture non-linearity in data. Support Vector machine (SVM) is a linear classifier with a kernel capturing data non-linearity. The methods proposed herein consider data existing in a space [symbol] and an additional finite-dimensional kernel Hilbert space [symbol] where there exists a map ψ: [symbol] =→ [symbol] .

Data is expressed in the kernel Hilbert space by applying the feature map ψ(x) to each data point x, and data similarity in the kernel Hilbert space is determined from the inner product k(x,x′)= [symbol] ψ(x),ψ(x′) [symbol] . This inner product, known as the kernel function, represents a distance between data points in some feature space.

The Gram matrix is constructed from the kernel function where each element, as presented in EQ. 1, quantifies data point distance in the kernel Hilbert space.

$${K}_{i j} = 〈 ψ ( {x}_{i} ) , ψ ( {x}_{j} ) 〉 , \qquad ( 1 )$$

It has been shown that expression of data in quantum Hilbert space can potentially better capture data non-linearity and improve machine learning performance. The methods proposed herein define a kernel function to quantify the distance between the data points in quantum feature space, as presented in EQ. 2,

$${K}_{i j} = {e}^{- α {‖ ρ ( {x}_{i} ) - ρ ( {x}_{j} ) ‖}_{F}^{2}} \qquad ( 2 )$$

where, as presented in EQ. 3,

$${‖ A ‖}_{F} = \sqrt{T r ( {AA}^{†} )} , \qquad ( 3 )$$

is the Frobenius norm and α is a hyper-parameter that controls kernel generalization. The density matrix ρ(x) captures information about the data point in quantum feature space, and the overlap of two data points is obtained from the difference of two density matrices. The full density matrix is approximated using the one-reduced density matrix (1-rdm) on a single qubit n such that, as presented in EQ. 4,

$${ρ}_{1}^{n} ( x ) = \hat{I} + 〈 {\hat{σ}}_{x}^{n} ( x ) 〉 {\hat{σ}}_{x} + 〈 {\hat{σ}}_{y}^{n} ( x ) 〉 {\hat{σ}}_{y} + 〈 {\hat{σ}}_{z}^{n} ( x ) 〉 {\hat{σ}}_{z} \qquad ( 4 )$$

and <â> is the expectation value of some operator â on the wave function |ψ [symbol] . The reduced kernel function in quantum feature space is expressible analytically using expectation values yielding, as presented in EQ. 5,

$${K}_{i j} = {e}^{- α {\sum }_{n = 0}^{m - 1} [ {( 〈 {\hat{σ}}_{z}^{n} ( {x}_{i} ) 〉 - 〈 {\hat{σ}}_{z}^{n} ( {x}_{j} ) 〉 )}^{2} + {( 〈 {\hat{σ}}_{x}^{n} ( {x}_{i} ) 〉 - 〈 {\hat{σ}}_{x}^{n} ( {x}_{j} ) 〉 )}^{2} + {( 〈 {\hat{σ}}_{y}^{n} ( {x}_{i} ) 〉 - 〈 {\hat{σ}}_{y}^{n} ( {x}_{j} ) 〉 )}^{2} ]} \qquad ( 5 )$$

A data vector x with m features such that x=(x₁, . . . , xₘ) is first rescaled to scalar values on a real interval and then mapped to a quantum state on m qubits |ψ(x) [symbol] using a parameterized unitary operator U(x) such that, as presented in EQ. 6,

$${\vert ψ ( x ) 〉 = U ( x ) \vert + 〉}^{m} \qquad ( 6 )$$

The state is first initialized in a uniform superposition |+ [symbol] ^{m} by the application of a Hadamard gate on each of the m qubits of a |0 [symbol] state. Then, the unitary operator U(x) rotates the state within the Hilbert space differently for each data point x.

The unitary operator U(x) may be defined as a sequence of exponential operators, as presented in EQ. 7,

$$U ( x ) = {( {e}^{- i {H}_{X X} ( x )} \cdot {e}^{- i {H}_{Z} ( x )} )}^{r} \qquad ( 7 )$$

where r is a tunable parameter that determines the number of layers in the circuit, and H_{Z}, H_{XX} are Hamiltonians describing single-qubit and two-qubit interactions, as presented in EQS. 8 and 9,

$${H}_{Z} ( x ) = γ {\sum }_{i = 1}^{m} {x}_{i} {\vec{σ}}_{i}^{Z} \qquad ( 8 )$$

$${H}_{X X} ( x ) = {γ}^{2} \frac{π}{2} {\sum }_{( i , j ) ∈ G} ( 1 - {x}_{i} ) ( 1 - {x}_{j} ) {\vec{σ}}_{i}^{X} {\vec{σ}}_{j}^{X} . \qquad ( 9 )$$

Thus, the unitary operator U(x) may be similar to a Trotterized evolution of a quantum spin model Hamiltonian. The qubit interaction topology in H_{XX} is captured by the edges of a graph G, which may correspond to a linear chain with tunable interaction distance. Additional edges in the graph G may contribute to more generators that define the underlying Lie algebra encoding the data, which increases the feature map expressivity. The real coefficient, γ, may control the kernel bandwidth and may be used to scale to larger quantum feature spaces.

At step 250, the method 200 includes training, by the machine learning model trainer 140, the target machine learning model data architecture using the quantum computing enhanced training data set to generate an output trained target machine learning model data architecture.

In some embodiments, the tensor network represents a quantum state of the feature map using a Matrix Product State (MPS) architecture, which enables tasks such as dimensionality reduction and feature extraction. In this case, a matrix product state is used for wavefunction representation, and a matrix product operator is used to represent one or more quantum gates used for conducting operations on the tensor network.

In some embodiments, the plurality of processors 104 utilize round-robin parallelization strategy for generating the quantum kernel. In this case, each processor 104 first computes an initial set of expectation values corresponding to the data batch, and receives a set of expectation values from another processor of the plurality of processors 104 relating to a next data batch. Each processor 104 then computes expectation values between the data batch and the next data batch, continuing until all kernel elements of the quantum kernel are determined using different pairs of expectation values.

In some cases of the abovementioned embodiment, each processor 104 is configured to send states to another processor 104 in accordance with the round-robin parallelization strategy until all Gram matrix entries are computed.

In some cases of the abovementioned embodiment, that matrices used to compute the Gram matrix are the rectangular kernel matrices, the round-robin parallelization strategy is based on processors 104 grouped to handle square tiles, with remaining processes corresponding to non-square tiles receiving Matrix Product State (MPS) subsets from the grouped processors 104 through additional message passing.

In some embodiments, during inference, when a new inference data point is provided for classification to the trained target machine learning model data architecture, the new data point is first processed using the parameterized quantum circuit for simulation as a Matrix Product State for generation of an inference kernel, and the inference kernel processed against a plurality of stored expectation values and the target machine learning model data architecture to generate a classification output.

In some cases of the abovementioned embodiment, the trained target machine learning model data architecture is configured for fraud detection. That is, the new inference data point is a data point having data fields corresponding to features of a transaction, and the generated classification output from the trained target machine learning model data architecture is a logit corresponding to an estimated probability that the new inference data point is classified in accordance with a specific label.

In some cases of the abovementioned embodiment, the specific label is a binary classification between fraudulent and non-fraudulent.

In some embodiments, the processors 104 include a combination of both central processing units (CPUs) and graphics processing units (GPUs).

In some cases of the abovementioned embodiment, the processors 104 are networked distributed computing resources that are selected and provisioned for usage based at least on a determination of a bond dimension characteristic corresponding to the quantum feature map used for the quantum kernel enhanced training, the determination including generating a small-scale preliminary version of the quantum kernel for performance analysis.

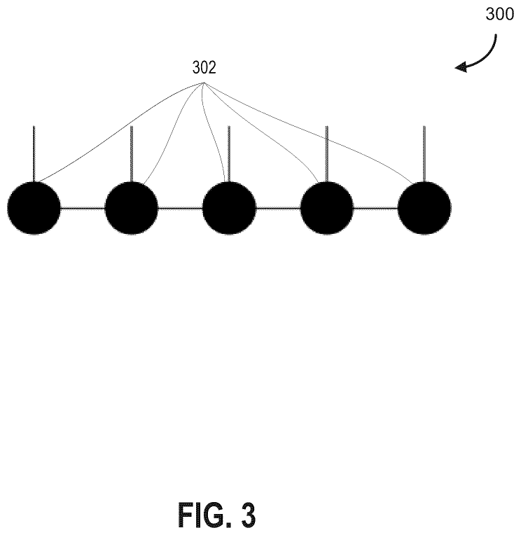

Now referring to FIG. 3, there is shown a diagrammatic representation 300 of a Matrix Product State (MPS), in which the nodes are tensors 302, the vertical lines represent physical indices, and the horizontal lines are virtual indices between tensors.

The state of an m-qubit quantum computer can be represented by a vector with 2^{m} complex entries. Simulating such quantum computations on classical computers involves storing this state vector and applying matrix multiplications for each gate in the quantum circuit. However, due to the exponential growth in the number of entries with increasing qubits, simulating circuits of large size, e.g., with more than 30 qubits, becomes highly resource-intensive.

An alternative approach involves representing the quantum state as a tensor network, particularly as an MPS. While MPS methods also experience exponential scaling, the scaling is related to the entanglement in the system rather than the number of qubits. This allows for more efficient simulations, especially for circuits with many qubits but low entanglement.

Tensors 302, which are multidimensional arrays, are contracted along common bonds to form new tensors 302. For example, contracting tensors 302 Xₗₘₛ and Y_{sabc} along bond s yields a new tensor, as presented in EQ. 10,

$${C}_{lmabc} = {\sum }_{s = 0}^{{χ}_{s} - 1} {X}_{l m s} \cdot {Y}_{s a b c} \qquad ( 10 )$$

where χₛ is the bond dimension. Tensors 302 can also be reshaped, such as transforming tensor 302 C_{lmabc} into a matrix Mᵢⱼ as presented in Eq. 11:

$${M}_{i j} = {C}_{l m a b c} where \begin{matrix}i = l + m \cdot {χ}_{l} , \\ j = a + ( b + c \cdot {χ}_{b} ) {χ}_{a} .\end{matrix} \qquad ( 11 )$$

One advantage of MPS arises when the virtual bond dimension χ is small, making the total number of entries 2mχ² significantly smaller than 2^{m}. This provides substantial memory savings and allows for faster simulations.

During the application of quantum gates, the bond dimensions may increase, requiring the use of singular value decomposition (SVD) to manage them. SVD factorizes a tensor 302 into a sum, as presented in EQ. 12:

$${C}_{j k l m} = {\sum }_{i} {s}_{i} {X}_{j k i} {Y}_{ilm} , \qquad ( 12 )$$

where sᵢ are singular values. Truncation of small singular values reduces bond dimensions, with the truncation error quantified by EQ. 13, as follows:

$${\vert 〈 {ψ}_{ideal} , {ψ}_{trunc} 〉 \vert}^{2} = 1 - \sum {s}_{i}^{2} \qquad ( 13 )$$

Expectation values on each of the qubits are extracted after simulation of the quantum circuit using matrix product states. The operator \hat{σ}ₚ where p∈{X, Y, Z} is a matrix product operator that connects to a physical index representing a qubit, and all other physical indices on the matrix product state that do not connect with a Pauli operator evaluate to identity.

As described herein, MPS has been proved to provide an efficient and scalable method for quantum simulation, particularly in systems with low entanglement, offering significant computational advantages over traditional state vector representations.

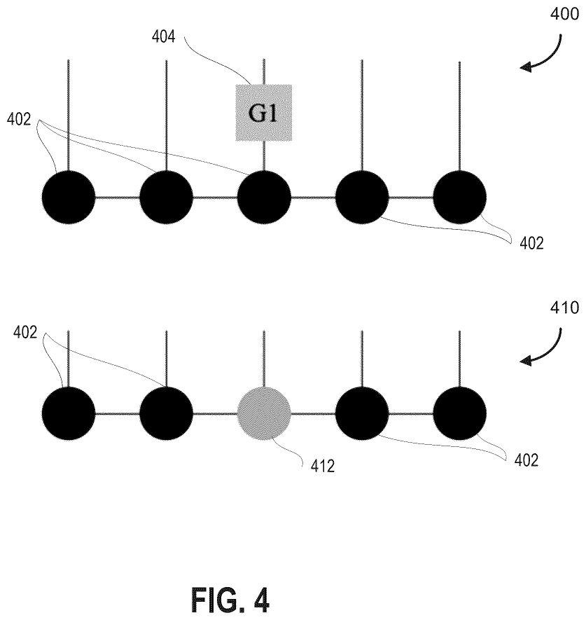

Now referring to FIG. 4, there is shown diagrammatic representations 400, 410 of Matrix Product States (MPS), in accordance with some embodiments. The diagrammatic representations 400, 410 includes a network of tensors 402. The diagrammatic representation 400 shows an application of a single qubit gate 404 represented as a G1 Matrix Product Operator (MPO) on a state represented as an MPS. It will be appreciated that the qubit gate 404 represents any unitary operator acting on a single qubit. In the matrix form, the qubit gate 404 represents any 2×2 unitary matrix. The diagrammatic representation 410 shows single-qubit gates that are contracted with the corresponding site tensor 412. It will be appreciated that the site tensor 412 denotes the qubit gate 404 being contracted with a tensor. The qubit gate 404 is thus absorbed in the MPS at the site tensor 412. The diagrammatic representation 410 also shows two-qubit gates that are applied in three steps. The first step includes contracting with the two MPS tensors. The second step includes applying SVD decomposition on the result. The third step includes contracting the diagonal tensor of singular values with either of the other tensors resulting from the decomposition.

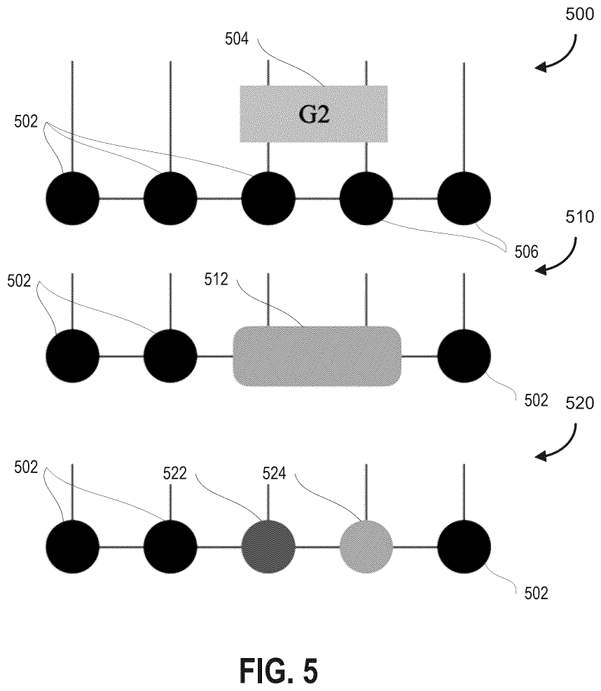

Now referring to FIG. 5, there is shown diagrammatic representations 500, 510, 520 of Matrix Product States (MPS), in accordance with some embodiments. The diagrammatic representations 500, 510, 520 includes a network of tensors 502. The diagrammatic representation 500 shows an application of a two qubit gate 504, which is an operator that is represented as an MPO on a state represented as an MPS. In other words, the two qubit gate 504 represents any non-separable, unitary operator acting on two qubits and, in the matrix form, it represents any 4×4 unitary matrix. The diagrammatic representation 510 shows a two qubit gate MPO 512 being contracted with two physical indices of the MPS. The two qubit gate MPO 512 represent the two bit gate 504 being contracted with two single site tensors, which are mixed. The diagrammatic representation 520 shows an application for performing singular value decomposition and contract the singular value tensor 522 with one of the other MPS tensors 524 in decomposition. This operation can be performed by performing singular value decomposition on the two qubit gate MPO 512 and then contracting the singular value tensor 522 with the neighboring tensor 524.

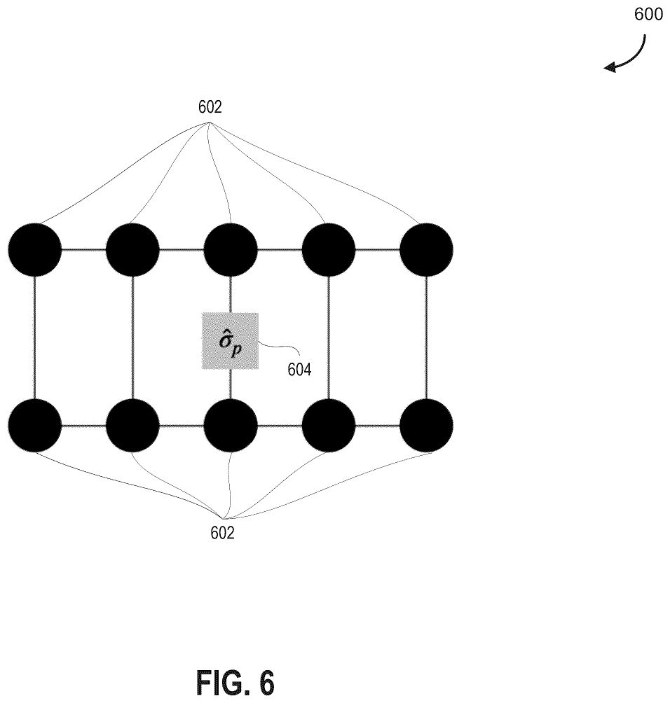

Now referring to FIG. 6, there is shown a diagrammatic representation 600 having tensors 602 and a Pauli operator 604. The diagrammatic representation 600 shows an expectation value of the Pauli operator 604 represented as an MPO on an MPS. In this case, only the physical indices with a Pauli operator are contracted and the rest evaluates to identity. The Pauli operator 604 is an SU(2) matrix, which is a 2×2 matrix, the basis of which are orthogonal to each other. The Pauli operator 604 basis are composed of σₓ, σ_{y}, σ_{z} and an identity. It will be appreciated that the Pauli operator 604 is used to extract information about a wavefunction (or MPS) by taking an expectation value. The overlap of a normalized wavefunction with itself and without the Pauli operator 604 is 1, i.e., <ψ|ψ=1 The expectation value <ψ|σ|ψ> gets the overlap of the wavefunction, extracting information about on each qubit in each basis of the Pauli operator 604. The output is a real, scalar value. In the diagrammatic representation 600, the expectation value of a general Pauli operator 604 is performed on the tensors 602 connected thereto. All surrounding tensors 602 are acted on by the Pauli operator 604 and do not contribute to the scalar. In the diagrammatic representation 600, the Pauli operator 604 is contracted with the top and bottom MPS (which are the same MPS) and the output is a real, floating point number.

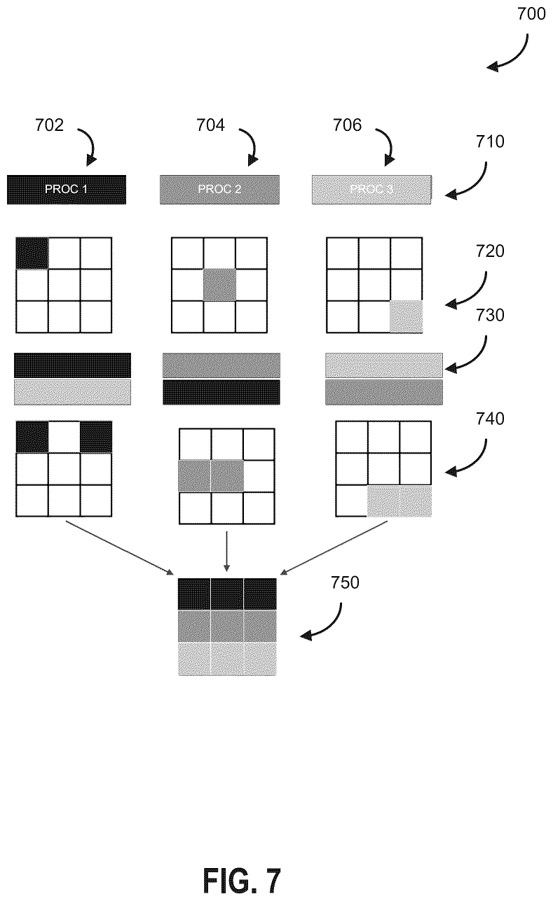

Now referring to FIG. 7, there is shown a round-robin parallelization process 700 for computing a Gram matrix. The process 700 receives three processor data chunks 702, 704, 706 for input.

At step 710, the process 700 includes simulating matrix product states and computing expectation values [symbol] σ [symbol] for each processor data chunks 702, 704, 706.

At step 720, the process 700 includes computing a tile of the Gram matrix for each processor data chunks 702, 704, 706.

At step 730, the process 700 includes sending expectation values from process n−1 to process n.

At step 740, the process 700 includes computing the next tile after the processor receives new expectation values. Steps 730, 740 are repeated until the round-robin parallelization is complete.

At step 750, the process 700 includes gathering matrix strips into a complete Gram matrix.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

It will be appreciated that kernel computation is highly parallelizable, with each datum |ψ(x) [symbol] and each kernel element kᵢⱼ computed independently of other datums and other kernel elements. The data is divided into chunks, assigning each chunk to a process. Each process performs two tasks: simulating circuits to extract expectation values for that data chunk and calculating the projected quantum kernel function using the state expectation values to fill the tile entries. The process 700 is memory efficient as only the expectation values which are real numbers need to be stored in memory with a total memory footprint of O(3 mN) for m qubits and N data points.

In the process 700, the circuits are evenly distributed among processes such that each circuit is simulated one time. Each process computes all kernel elements for all of its expectation values. Subsequently, process n−1 sends half of its states to process n, which computes the kernel elements between the received expectation values and its expectation values. This continues until all Gram matrix entries are computed, with each process responsible for a row of tiles. After all entries are computed, the tiles are combined either by gathering tiles on a common process or using some other form of storage like hard-disk memory.

For symmetric Gram matrices, the computation can be reduced by half. For rectangular kernel matrices used in inference, the round-robin strategy is slightly adjusted: processes are grouped to handle [symbol] × [symbol] tiles, with remaining processes receiving necessary MPS subsets from the first group through additional message passing.

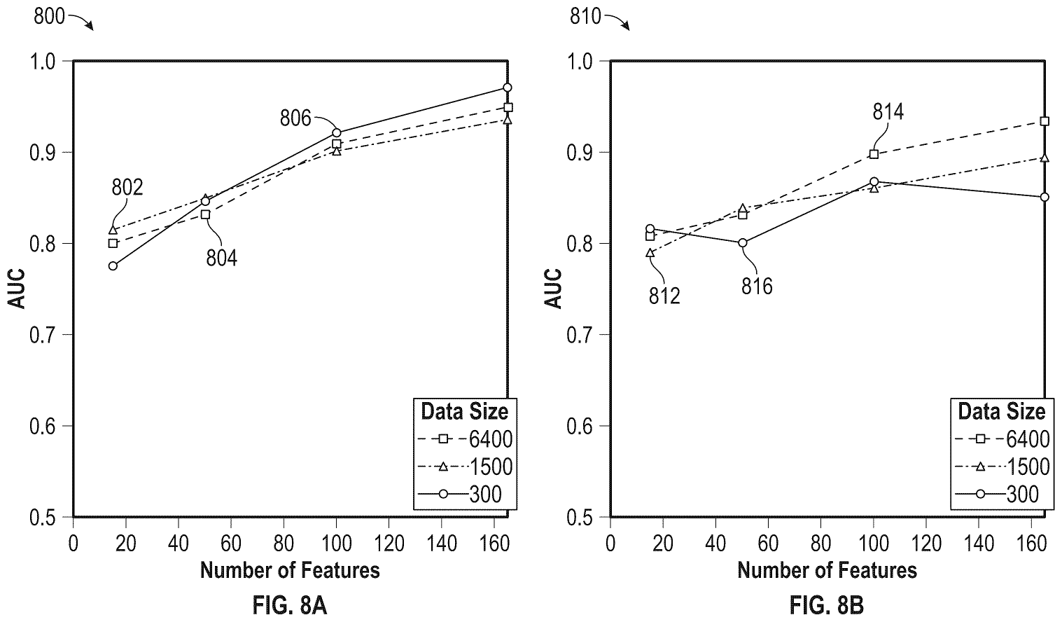

Now referring to FIGS. 8A-8B, there are shown graphs 800, 810 of the area under the curve (AUC) prediction score as a function of the number of features. Graphs 800, 810 are representative of data sample sizes on the Elliptic Bitcoin data set with increasing feature number. The curves 802, 812 represent test sets having 64,000 data points, the curves 804, 814 represent test sets having 15,000 data points and the curves 806, 816 represent test sets having 300 data points.

The performance is modelled with a quantum kernel computed using a simulator, with the SVM model applied to the Elliptic Bitcoin data set. This data set has 165 features corresponding with 4,545 data points labeled illicit and 42,019 data points labeled licit transactions, allowing to push the simulator to regimes modern quantum computers have yet to reach, and beyond what state vector simulators can support.

An aim is to explore classification capabilities at data volumes and feature dimensions unlocked through the simulator framework. Another aim is to assess how increasing expressivity through the interaction distance or number of circuit layers affects the model's classification performance. Data is prepared using a data engineering pipeline to normalize and scale the data. Data samples are down selected and seeded to a specified dimension with balanced data and an 80/20 train-test split. SVM regularization parameter C∈[0.01,4] and the tolerance for SVM is 10⁻³. Model performance is assessed using metrics including accuracy, recall, precision, and AUC. The AUC metric quantifies the area under the Receiver Operating Characteristic (ROC) curve where the y-axis has the true positive rate and x-axis has the false positive rate [11]. AUC can capture a classifier's capability to distinguish between true positives and false positives at a given threshold. Thus, this metric is often used to quantify classification performance.

SVM performance can be assessed with a quantum kernel at a previously unachieved scale, which provides insight into the interplay of large feature dimension and training data size in achieving quality results on the test data set. The train data kernel and the test data kernel are supplied to the standard SVM classifier for data sample sizes of 300, 1500, and 6400 with 15, 50, 100, and 165 features. A linear ansatz has been used with interaction distance of one (d=1), two encoding circuit repetitions (r=2), and γ=0.1. The quality of training is displayed in FIG. 8A by testing how well the trained SVM predicts the correct labels of the training data set. More importantly, it has been assessed how the trained SVM correctly predicts on the test data set in FIG. 8B. Both the training and test prediction quality continues to improve as more features are added. The prediction score on the training data set achieves its highest value when trained on 300 samples, which is likely an indicator of model overfitting. This is observed in the prediction score of the test data set: the test score for the data sample size of 300 does not improve consistently with the addition of more features with an equivalent 0.933 AUC score with both 100 features and 165 features. In contrast, consistent classification quality improvement has been observed on the test data set with data sample size 6400 with a 2.44% AUC improvement using 165 features over 100 features. This observation is indicative that more training data is needed to avoid model overfitting as the feature dimension increases. Scaling to larger amounts of training data is achievable with our parallelization strategy and the addition of more processors. These large-scale simulations reveal that model performance is improved with the addition of more qubits (i.e. more features) and the addition of more training data which is a notable and promising result for near term quantum machine learning algorithms. While simulation scale is feasible, careful consideration is needed to see how quantum circuit complexity affects model performance.

TABLE 1
SVM performance with 50 features and 2 encoding circuit
repetitions. Experiment with highest AUC marked in bold.

| kernel | d | γ | AUC | Recall | Precision | Accuracy |
|---|---|---|---|---|---|---|
| Gaussian | — | — | 0.892 | 0.883 | 0.898 | 0.892 |
| quantum | 1 | 0.1 | 0.877 | 0.883 | 0.874 | 0.877 |
| quantum | 2 | 0.1 | 0.877 | 0.883 | 0.874 | 0.877 |
| quantum | 4 | 0.1 | 0.877 | 0.883 | 0.874 | 0.877 |
| quantum | 6 | 0.1 | 0.877 | 0.883 | 0.874 | 0.877 |
| quantum | 1 | 0.5 | 0.902 | 0.933 | 0.879 | 0.902 |
| quantum | 2 | 0.5 | 0.900 | 0.946 | 0.867 | 0.900 |
| quantum | 4 | 0.5 | 0.904 | 0.946 | 0.874 | 0.904 |
| quantum | 6 | 0.5 | 0.881 | 0.937 | 0.843 | 0.881 |
| quantum | 1 | 1.0 | 0.898 | 0.950 | 0.863 | 0.898 |
| quantum | 2 | 1.0 | 0.894 | 0.942 | 0.861 | 0.894 |
| quantum | 4 | 1.0 | 0.898 | 0.962 | 0.853 | 0.898 |
| quantum | 6 | 1.0 | 0.887 | 0.975 | 0.831 | 0.887 |

Expressivity is quantified by circuits that require a higher bond dimension, which is induced by longer qubit interaction distances, more circuit layers, and the value of the γ coefficient. Table 1 illustrates how tuning these circuit ansatz hyperparameters affects the resource requirements of the proposed framework.

Embodiments show experiments aimed to elucidate the effect of circuit complexity on model performance using 50 features. Each run consists of 6 data samples and the metrics are averaged over the 6 runs with the same regularization parameter. Each implementation with different specifications is independent of previous runs, and the best performing model for a given regularization coefficient is chosen independently.

The goal is to determine which attribute—interaction distance, depth, or γ—has the largest effect on model performance. Embodiments of the present technology have been experimented with the circuit ansatz for d∈(1,6) and using coefficients γ=(0.1,0.5,1). Machine learning performance metrics are compared to the SVM algorithm with the common Gaussian kernel, as shown in EQ. 14,

$${e}^{- α {\vert x - {x}^{′} \vert}^{2}} . \qquad ( 14 )$$

The bandwidth parameter has been chosen such that α=1/[m·var(X)] for some data set X. The regularization parameter range and tolerance for SVM with a Gaussian kernel are equivalent to the quantum kernel experiments. Performance on the test data set using these models is detailed in Table 1. None of the models with γ=0.1 outperformed the classical model.

Further increasing interaction distance for small γ has little impact on model performance which is likely due to very small interaction coefficients in the encoding Hamiltonian. The quantum model did outperform the classical model with γ∈{0.5,1}, and the interaction distance impact on model quality is clearer as the larger two qubit interaction coefficients generate more correlation. It has been shown that d=4 demonstrates the best performance with γ=0.5 while d=1 demonstrates the best performance with γ=1. Model performance diminishes when d=6 and γ∈{0.5,1} which results from an overly expressive model that overfits the train data set. The effect of kernel bandwidth (γ) and the inclusion of more generators (d) on model performance indicates there is a parameter regime to achieve better quality generalization for the quantum model which will likely have a data set dependence.

TABLE 2
Ansatz repetition effect on SVM performance
on 50 features d = 1 and γ = 1.
Experiment with highest AUC marked in bold.

| depth | AUC | Recall | Precision | Accuracy |
|---|---|---|---|---|
| 2 | 0.898 | 0.950 | 0.863 | 0.898 |
| 4 | 0.900 | 0.975 | 0.849 | 0.900 |
| 8 | 0.844 | 0.996 | 0.765 | 0.844 |
| 12 | 0.810 | 1.000 | 0.727 | 0.810 |
| 16 | 0.810 | 0.987 | 0.732 | 0.810 |
| 20 | 0.798 | 0.992 | 0.717 | 0.798 |

Circuit depth, induced by repeated ansatz repetitions, further increases the simulation complexity and model expressivity. It has been assessed how circuit depth influences both train and test performance for the best performing configuration above. Increasing the depth leads to kernel concentration, which is known to cause model untrainability [25]; this phenomenon is apparent in the results shown in Table 2. Increasing the depth significantly diminishes model performance on the test data set. Intuitively, more applications of the ansatz rotate data points farther away from each other, such that the overlaps become increasingly small; therefore, no useful information is extracted from the feature map.

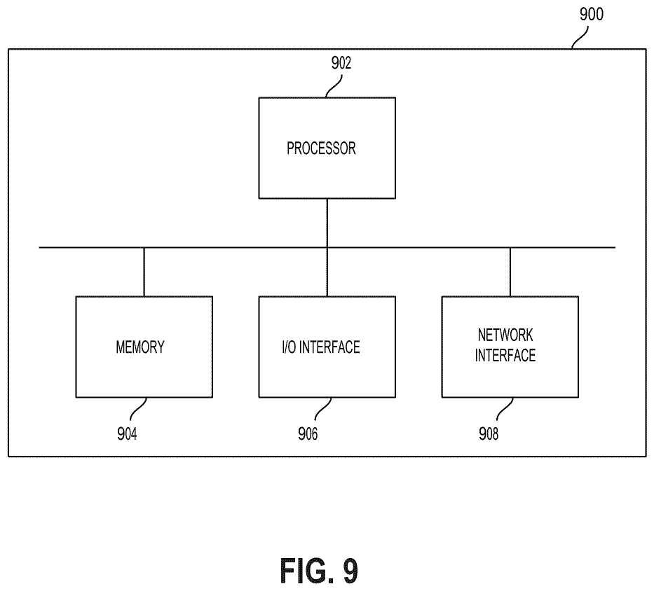

FIG. 9 is a schematic diagram of an electronic device 900 for quantum kernel enhanced training of a target machine learning model data architecture. As depicted, electronic device 900 includes at least one processor 902, memory 904, at least one I/O interface 906, and at least one network interface 908.

Each processor 902 may be, for example, a microprocessor or microcontroller, a digital signal processing (DSP) processor, an integrated circuit, a field programmable gate array (FPGA), a reconfigurable processor, a programmable read-only memory (PROM), or combinations thereof.

Memory 904 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 906 enables electronic device 900 to interconnect with one or more input devices, such as a keyboard, mouse, camera, touch screen and a microphone, or with one or more output devices such as a display screen and a speaker.

Each network interface 908 enables electronic device 900 to communicate with other components, to exchange data with other components, to access and connect to network resources, to serve applications, and perform other computing applications by connecting to a network (or multiple networks) capable of carrying data.

In a specific, non-limiting example, consider an approach where the system is being used for training and inference in respect to high dimensionality fraud data. In this example, the system would first operate by constructing a quantum kernel to evaluate data similarity within a Quantum Hilbert space, using tensor networks to simulate quantum circuits in an effort to capture non-linearity.

In this example, high dimensionality fraud data can be provided in the form of training data based on ground truth labels. With a greater amount of dimensionality, a greater ability for classification and accuracy can be obtained as the number of signals for machine learning grows. However, this growth comes at the cost of scalability and resource usage. As noted herein, simulating quantum circuits with an increased number of qubits can become highly resource intensive.

Accordingly, in this example, the fraud data, following the transformation, uses a tensor network to represent the quantum state, as a Matrix Product State (MPS). For illustration, the Matrix Product State representation can be contemplated as a quantum state of multiple particles (or sites) as a product of matrices. Using the MPS allows for more computationally efficient simulation, especially for fraud examples where the circuits may have many qubits but low entanglement. For fraud applications, in practical usage, MPS is particularly useful because the virtual bond dimension is small, and in this example, Applicants suggest that there will be substantial memory savings and simulations.

In some embodiments, the high dimensionality and non-linear fraud data (e.g., hundreds of features) includes historical labelled transactional data spanning at least one year prior to the training of the machine learning model. In this case, the labelled fraud from the prior year may be included in the training data set. The non-fraudulent transactions may be sampled from annual year, either randomly, or designed to capture span of transactional dynamics. The preferred fraud to non-fraud data ratio, which represents the proportion of fraudulent transactions to non-fraudulent transactions in the data set, may vary and be, in some cases, of about 1:3. The transactional data may include relevant features (e.g., the location, the type of transaction, the amount of assets in the transaction, etc.). The data may be pre-processed to encode categorical feature numerically, which may be referred to as one-hot encoding. In some implementations, all features must have numerical values, strings must be encoded in some form (binary) to load into the model or excluded entirely. The kernel approach proposed herein is specially adapted to handle high dimensional, non-linear data. The kernel approach proposed herein utilizes feature maps that are applied to the training data set, and the function space captured by the feature map is more expressive and generalizes better relative to other approaches.

In some embodiments, a feature selector is used to determine the importance of each data feature in the model outcome. Features that show little significance in model improvement may be discarded by the feature selector. The model complexity increases with feature number and a low feature number, e.g., fewer than 200 features, is preferred for fast performance. For example, the number of features can be reduced to 100-200 (while the approach may start with several thousand features). The data is then transformed and scaled on suited increments, e.g., on increments of pi.

During training, the data of the selected features is first fed to the tensor subroutine. After this step, the quantum kernel is constructed, according to the method 700. The features and values may have been scaled to an appropriate level of values (e.g., in accordance with a scaling factor), and ansatz may be selected (e.g., which group generators to use), and the quantum circuit is constructed for the training data. The quantum circuit is used for all training data and all test data. Each data point has a single circuit, and the circuit is simulated using the MPS approach to obtain the expectation value for each qubit independently used to construct the exponential kernel. Once everything is simulated, all of the expectation points are stored in memory. Each processor can be provided with a batch of training data (more processors for more training data), and there are the expectation values associated with each training data (so the circuits are not needed anymore). In the round-robin strategy, each processor will process a “strip” of the kernel matrix, and each element is calculated using an analytical function (e.g., equation 5 as noted above) described herein that compares the differences between the data points by using the differences between the expectation values that are being passed in the round-robin approach. Each datapoint is calculated against each other, and the process loops through to get every kernel element. Once each strip is conducted, each expectation value can be saved and stored and loaded later for inference.

In some cases, a gather function can be used to gather all of the strips together to a root processor to reconstruct a full matrix. Alternatively, each strip can be loaded into memory, and can be separately used to reconstruct a full matrix.

Once pre-computed, the quantum kernel is fed to a Support Vector Machine (SVM) or another suited kernel algorithm. SVM can be instantiated as an SVM class that can use a pre-computed kernel from the pre-computed matrix. Given regularization parameters and hyperparameters, the model is fit to the training data, that is, using the kernel matrix associated with the training data and the labels associated with the training data. With the quantum kernel computed, the model is fitted and the decision boundaries are obtained. As noted herein, the SVM processing can be conducted using parallel processing using extracted strips.

At this point, a model is trained. The model can be tested to see how well it was trained by running a prediction algorithm using a same training kernel and a same training label, and the scores (e.g., AUC score, recall, accuracy, precision) can be observed. Stratified K-fold cross-validation can be conducted for validation. There can be a set of hyperparameters under test. Optuna™, for example, can be used to hyperparameter selection along with resilience testing.

Once optimized and trained, the model is then used for prediction on test data set. The test data set may include various types of imbalanced and realistic fraud to non-fraud data ratio, such as, but not limited to, 1:10, 1:100, 1:1000, etc. In some cases, the train data and the test data may be obtained from different periods in the transaction log.

During testing, expectation values of train data used to compute quantum kernel are loaded, either from memory or hard disk, for test task. The quantum kernel is then computed for test data in batches, which can be parallelized. It will be appreciated that the same hyperparameters are used from train optimization in test kernel construction. Test kernels are then fed to trained Support Vector machine model for predictive scoring. Relevant model KPIs (accuracy, AUC, false positive ratio, etc.) are thereafter extracted in order to compare proposed model against other models and to assess model performance. The probability threshold is then tuned to optimize the false positive rate. For instance, a 20:1 fraud to non-fraud data ratio in test may be set as a baseline for production use. In some cases, upon meeting fraud detection criteria during, the model may be deployed onto a transaction modelling system in the production environment.

During inference, trained model training data expectation values are loaded, and circuit structure is loaded onto a transaction monitoring system (TMS) which includes either a single CPU or a CPU cluster. The TMS receives streaming data from client transactions from suitable sources. In this case, the streaming data must contain the same feature specifications as the train data, which may include the type of feature and the number of features. The incoming transaction data meeting model requirements (e.g., limited to the same selected features as identified during training in pre-process) is then pre-processed in the same pipeline as the train data.

The data is loaded into the quantum circuit, simulated, and expectation values are then extracted. The quantum circuit constructed for the training data is the same one to be used during inference (e.g., the quantum circuit may have been held in memory). Because it has the same features, it has the same size. A quantum circuit can be constructed for the incoming transaction. The quantum circuit is simulated and the expectation values are extracted (that can be used for determining the distance as noted below). The distance between transaction data point and training data is then computed. As there is a high dimensional space constructed in the quantum feature space, one can contemplate that there are clusters of points, and the SVM algorithm creates decision boundaries and slices through the data, and the distance can be used to determine where a point falls within a decision boundary for classification. For example, if a point falls within a boundary, it could be labelled as positive (e.g., fraudulent), and outside of the boundary, it could be labelled as negative (e.g., not fraudulent).

The quantum kernel, which is a vector, is then computed using streaming data. The quantum kernel is thereafter fed to the trained model for prediction to generate a label of whether something is fraudulent or not (e.g., a binary output or a probability score [e.g., p(Fradulent)=x).

The output of this example fraud detection process includes an optimized trained machine learning model, which is a data structure that can be utilized to control or automatically invoke downstream computing subroutines and/or processes. For example, if a high confidence classification (e.g., >threshold) of fraud is determined, the system can automatically modify a transaction to add a flag to the data structure, block a pending transaction, or reverse an existing transaction. In other words, a transaction that is not classified as fraud passes through for payment and a transaction that is fraudulent is stopped and passed to a fraud analyst for further review.

In some embodiments, hyperparameter optimization may be performed using either stratified k-fold cross validation or using a model optimizer, such as like Optuna™. The optimization may be performed using Area Under the Curve (AUC) metric which quantifies discriminability. The hyperparameters may include, for the Support Vector machine, regularization and optimization tolerance, and for the quantum kernel, bandwidth parameters and number of encoding layers.

In some embodiments, the machine learning models may be tested via a resilience test. In the case of training a data set, noise may be introduced in the train data, and by performing the response of the model to the training using such train data, determining how resilient is the model to the introduced noise. A similar approach may be performed on a trained model. It will be appreciated that resilience tests are performed to determine a model's generalization capabilities and ensure robustness. In some embodiments, the noise includes mislabeling data.

If something is considered fraudulent, a transaction can be blocked (e.g., the data process can be stopped), or flagged for review. In some cases a text message can be sent to the user for approval of the transaction. In the case of no credit card fraud, a transaction flagged for review can be reviewed by an analyst. A benefit of the approach is that the system can be used in operation in real-time or near-real time, and the proposed approach is more capable of handling non-linearities to obtain faster solutions. While decision tree solutions can be used as a comparison, decision trees are heavily limited by complexity, especially as the number of features increases. The proposed approach allows for both a large number of features and handling non-linearities. Finally, in the proposed approach, while the generation of the kernel can be computationally intensive, once the kernel is generated, the system is able to operate quickly during inference. Effectively, the heavier computational processing can be front-loaded into the training process during lower load times, and during inference time, the system is able to operate effectively and efficiently.

The embodiments of the devices, systems, and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and a combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other types of computer servers in a manner to fulfill described roles, responsibilities, or functions.

The functional blocks and modules described herein (e.g., the functional blocks and modules in FIG. 1) may comprise processors, electronic devices, hardware devices, electronic components, logical circuits, memories, software codes, firmware codes, etc., or any combination thereof. In addition, features discussed herein relating to FIG. 1 may be implemented via specialized processor circuitry, via executable instructions, and/or combinations thereof.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possess those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps (e.g., the logical blocks in FIG. 1) described in connection with the disclosure herein may be implemented as electronic hardware, computer software, or combinations of both. To clearly illustrate this interchangeability of hardware and software, various illustrative components, blocks, modules, circuits, and steps have been described above in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a processor, a digital signal processor (DSP), an ASIC), a field programmable gate array (FPGA) or other programmable logic devices, discrete gate or transistor logic, discrete hardware components, or combinations thereof designed to perform the functions described herein. A processor may be a microprocessor, but in the alternative, the processor may be another form of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a computer, or a processor. Also, a connection may be properly termed a computer-readable medium. For example, if the software is transmitted from a website, server, or other remote sources using a coaxial cable, fiber optic cable, twisted pair, or digital subscriber line (DSL), then the coaxial cable, fiber optic cable, twisted pair, or DSL, are included in the definition of medium. Disk and disc, as used herein, include compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus- or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system for quantum kernel enhanced training of a target machine learning model data architecture using a quantum feature map applied to training data set, the system comprising:
a plurality of computer processors, operating in conjunction with computer memory and non-transitory computer readable storage media, at least one processor of the plurality of processors configured to:
receive a corresponding data batch of the training data set;
receive a parameterized quantum circuit;
transform each data point in the data batch using the parameterized quantum circuit as the quantum feature map to convert the data point into a quantum-space data point having qubits based on a manifold space defined by the parameterized quantum circuit, each quantum-space data point having states represented using a tensor network;
generate a quantum kernel representing a quantum computing enhanced training data set wherein each data point of the training data set is expanded based on the expectation values of the qubits for capturing a distance between each data point in the manifold space by simulating quantum state overlaps associated with each data point; and
train the target machine learning model data architecture using the quantum computing enhanced training data set to generate an output trained target machine learning model data architecture.

2. The system of claim 1, wherein the tensor network represents a quantum state of the quantum kernel using a Matrix Product State (MPS) architecture, wherein a matrix product state is used for wavefunction representation, and a matrix product operator is used to represent one or more quantum gates used for conducting operations on the tensor network.

3. The system of claim 1, wherein the plurality of processors utilize a round-robin parallelization strategy for generating the quantum kernel, wherein each processor first computes an initial set of expectation values corresponding to the data batch, and receives a set of expectation values from another processor of the plurality of processors relating to a next data batch, and computes expectation values between the data batch and the next data batch, continuing until all kernel elements of the quantum kernel are determined using different pairs of expectation values.

4. The system of claim 3, wherein each of the plurality of processors are configured to send states to another processor in accordance with the round-robin parallelization strategy until all Gram matrix entries are computed.

5. The system of claim 4, wherein for rectangular kernel matrices, the round-robin parallelization strategy includes processors grouped to handle square tiles, with remaining processes corresponding to non-square tiles receiving MPS subsets from the grouped processors through additional message passing.

6. The system of claim 1, wherein during inference, when a new inference data point is provided for classification to the trained target machine learning model data architecture, the new data point is first processed using the parameterized quantum circuit for simulation as a Matrix Product State for generation of an inference kernel, and the inference kernel processed against a plurality of stored expectation values and the target machine learning model data architecture to generate a classification output.

7. The system of claim 6, wherein the trained target machine learning model data architecture is configured for fraud detection, wherein the new inference data point is a data point having data fields corresponding to features of a transaction, and the generated classification output from the trained target machine learning model data architecture is a logit corresponding to an estimated probability that the new inference data point is classified in accordance with a specific label.

8. The system of claim 7, wherein the specific label is a binary classification between fraudulent and non-fraudulent.

9. The system of claim 1, wherein the plurality of processors include a combination of both central processing units and graphics processing units.

10. The system of claim 9, wherein the plurality of processors are networked distributed computing resources that are selected and provisioned for usage based at least on a determination of a bond dimension characteristic corresponding to the quantum feature map used for the quantum kernel enhanced training and the amount of training data used for the model, the determination including generating a small-scale preliminary version of the quantum kernel for performance analysis.

11. A method for quantum kernel enhanced training of a target machine learning model data architecture using a quantum feature map applied to training data set, the method comprising:
receiving a corresponding data batch of the training data set;
receiving a parameterized quantum circuit;
transforming each data point in the data batch using the parameterized quantum circuit as the quantum feature map to convert the data point into a quantum-space data point having qubits based on a manifold space defined by the parameterized quantum circuit, each quantum-space data point having states represented using a tensor network;
generating a quantum kernel representing a quantum computing enhanced training data set wherein each data point of the training data set is expanded based on the expectation values of the qubits for capturing a distance between each data point in the manifold space by simulating quantum state overlaps associated with each data point; and
training the target machine learning model data architecture using the quantum computing enhanced training data set to generate an output trained target machine learning model data architecture.

12. The method of claim 11, wherein the tensor network represents a quantum state of the quantum kernel using a Matrix Product State (MPS) architecture, wherein a matrix product state is used for wavefunction representation, and a matrix product operator is used to represent one or more quantum gates used for conducting operations on the tensor network.

13. The method of claim 11, further comprising utilizing a round-robin parallelization strategy for generating the quantum kernel, wherein each processor first computes an initial set of expectation values corresponding to the data batch, and receives a set of expectation values from another processor of the plurality of processors relating to a next data batch, and computes expectation values between the data batch and the next data batch, continuing until all kernel elements of the quantum kernel are determined using different pairs of expectation values.

14. The method of claim 13, wherein each of a plurality of computer processes are configured to send states to another process in accordance with the round-robin parallelization strategy until all Gram matrix entries are computed.

15. The method of claim 14, wherein for rectangular kernel matrices, the round-robin parallelization strategy includes processors grouped to handle square tiles, with remaining processes corresponding to non-square tiles receiving MPS subsets from the grouped processors through additional message passing.

16. The method of claim 11, wherein during inference, when a new inference data point is provided for classification to the trained target machine learning model data architecture, the new data point is first processed using the parameterized quantum circuit for simulation as a Matrix Product State for generation of an inference kernel, and the inference kernel processed against a plurality of stored expectation values and the target machine learning model data architecture to generate a classification output.

17. The method of claim 16, wherein the trained target machine learning model data architecture is configured for fraud detection, wherein the new inference data point is a data point having data fields corresponding to features of a transaction, and the generated classification output from the trained target machine learning model data architecture is a logit corresponding to an estimated probability that the new inference data point is classified in accordance with a specific label.

18. The method of claim 17, wherein the specific label is a binary classification between fraudulent and non-fraudulent.

19. The method of claim 11, wherein the plurality of processors include a combination of both central processing units and graphics processing units, and the plurality of processors are networked distributed computing resources that are selected and provisioned for usage based at least on a determination of a bond dimension characteristic corresponding to the quantum feature map used for the quantum kernel enhanced training and the amount of training data used for the model, the determination including generating a small-scale preliminary version of the quantum kernel for performance analysis.

20. A non-transitory computer readable medium storing machine interpretable instruction sets, which when executed by a processor, cause the processor to perform steps of a method for quantum kernel enhanced training of a target machine learning model data architecture using a quantum feature map applied to training data set, the method comprising:
receiving a corresponding data batch of the training data set;
receiving a parameterized quantum circuit;
transforming each data point in the data batch using the parameterized quantum circuit as the quantum feature map to convert the data point into a quantum-space data point having qubits based on a manifold space defined by the parameterized quantum circuit, each quantum-space data point having states represented using a tensor network;
generating a quantum kernel representing a quantum computing enhanced training data set wherein each data point of the training data set is expanded based on the expectation values of the qubits for capturing a distance between each data point in the manifold space by simulating quantum state overlaps associated with each data point; and
training the target machine learning model data architecture using the quantum computing enhanced training data set to generate an output trained target machine learning model data architecture.
